(19) United States
(12) Patent Application Publication
(10) Pub. No.: US 2002/0192333 A1
(43) Pub. Date: Dec. 19, 2002

(54) Milk resistant to acid coagulation, method and milk-based product

(76) Inventors: Jorge Florin Christensen, Buenos Aires (AR); Elena Florin, Buenos Aires (AR); Joseph Ballif Harris, Pullman, WA (US)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 10/134,205

(22) Filed: Apr. 26, 2002

Related U.S. Application Data
(60) Provisional application No. 60/286,694, filed on Apr. 27, 2001.

(51) Int. Cl. A23C 9/12

(52) U.S. Cl. 426/42

(57) ABSTRACT

Milk treated with protease, the milk having a resistance to acid coagulation that is higher than the resistance of a non treated milk, and the calcium bioavailability is increased for an animal consuming the treated milk, wherein the treated milk may be for direct consumption or for preparing food products. The milk is treated according to a method of the invention comprising adding a protease into the milk for obtaining a partial proteolysis, wherein the protease may comprise subtilisin, bromelain, papain, trypsin, pancreatin, proteases from Aspergillus sp, proteases from Tetrahymena sp, proteases from Bacillus subtilis, B. amyloliquefaciens and B. licheniformis and combinations thereof.

### BACKGROUND OF THE INVENTION

1. Field of the Invention

The invention relates to milk and milk-based products, specifically to milk treated with proteases under conditions that render it resistant to acid coagulation or clotting maintaining calcium complexes in stable suspension, thereby enhancing calcium bioavailability. The invention also relates to methods for treating milk by limited enzymatic proteolysis, to dairy products derived from said proteolyzed milk and to food products prepared with the proteolyzed milk of the invention.

For the purpose of the description of the present invention “animal” means any member of the kingdom Animalia, and includes human beings.

2. Description of the Prior Art

Calcium is an element that is necessary for animals, particularly for human beings, and is critical for many physiological functions such as neuro-transmissions, muscle contractions, glandular secretion, etc. In addition, calcium is an essential component of the bones, necessary for normal osseous structure. Any calcium absorption deficiency, particularly due to insufficient provision of vitamin D, leads to rickets and osteomalacia. A negative balance or poor availability of calcium is the main cause of osteoporosis, that is osseous fragility resulting in bone fractures and vertebrae collapses. One of the main calcium sources in a normal diet is the milk. However, it has been shown that only about 30% of milk calcium is bioavailable. In other words, only a third part of the calcium contained in milk is absorbed by the animal or human being consuming the milk.

In milk, a large fraction of the calcium is present as calcium phosphate micelles. These micelles are stabilized in colloidal suspension by caseins which are highly phosphorylated proteins. These proteins are characterized by the presence of clusters of phospho-serine residues which are negatively charged and have a tendency to neutralize with acidification. When neutralization occurs electrostatic repulsion between the micelles is weakened and the micelles can aggregate resulting in coagulation.

Milk coagulation or clotting by contact with acids is a normal event occurring in the acidic medium of the stomach of humans and other mammals. When milk coagulates, caseins aggregate, entrapping calcium phosphate micelles into large clumps, namely the coagulum. This process reduces the possibility of calcium diffusion and therefore it may account for the limited bioavailability of milk calcium.

It has been known that treatment of milk with some proteases, such as rennet, causes by itself milk coagulation and the coagulum is used for cheese making. The use of proteases to improve different aspects of milk or dairy products has been disclosed by other authors. Thus, U.S. Pat. No. 5,863,573 to Dambmann et al discloses a process for producing cheese, which process includes the steps of adding an enzyme preparation to milk so as to effect a limited specific hydrolysis of milk whey proteins, but which does not cause clotting of milk. Simultaneously with the addition of the enzyme preparation, a starter culture is added to the milk together with a milk-clotting enzyme. The purpose of treating milk with an enzyme preparation to effect a limited specific hydrolysis of whey proteins is to avoid the adverse effects on cheese texture and taste of retaining whey proteins in concentrated milk used for cheese making. It is clear that Dambmann et al discloses an invention relating to cheese making and not to fluid milk as the one corresponding to the present invention. In addition, Dambmann et al invention is not concerned with calcium bioavailability.

Okano et al (Japanese published patent application, publication No. 55088652 JP) describe the preparation of a sour soybean drink, by treating soybean milk with proteases and fermenting the milk with a lactic acid bacteria culture. The soybean milk is treated with protease to convert 30-50% of the protein to protein soluble in trichloroacetic acid. This soybean drink has a suppressed protein coagulation tendency. In addition to being applied to soybean, and not mammal milk, Okano's application is nor aimed at enhancing calcium stability in acidic medium neither to enhance calcium bioavailability, and it has no reference to sensory properties of the treated soybean milk, with regard to the starting soybean milk. Further, the final product is specifically meant to be fermented, generating a sour soybean milk product.

The prior art does not contain descriptions of methods to enhance the bioavailability of the calcium naturally occurring in milk. Calcium-fortified milk is available in the market as are other calcium-supplemented products, such as orange juice and other fruit beverages. Specific calcium supplements in tablets and other forms are also commercially available. However, there is general agreement that the bioavailability of calcium supplements is limited to about one third of the ingested calcium (Gueguen, L., Pointillart, A., 2000, The bioavailability of dietary calcium. Journal of the American College of Nutrition 19:119S-136S).

Enhanced calcium bioavailability can contribute to proper bone formation during youth and its conservation throughout adulthood. Milk is particularly appropriate to bone formation because it provides calcium phosphate and magnesium, essential components of bone. In addition, it provides amino acids and other important nutrients that contribute to bone building. Furthermore, there appear to be particular components in milk that stimulate bone reinforcement. The isolation of basic fractions of milk proteins by ion exchange chromatography and their use as intact molecules or after proteolysis has been proposed as the basis for a bone reinforcing agent. (U.S. Pat. No. 5,932,259 to Kato et al). It is noted that our present invention yields a food product, with the complete set of nutrients offered by milk, and not a food supplement as is the case of U.S. Pat. No. 5,932,259.

In addition to the foregoing, it is well known that the casein hydrolysis with trypsin may release phosphorylated peptides known as casein phosphopeptides that stimulates the calcium absorption. It is also known that solubility of calcium salts and complexes in acidic medium is necessary, but not sufficient for calcium bioavailability (Gueguen, L., Pointillart, A., 2000, The bioavailability of dietary calcium. Journal of the American College of Nutrition 19:119S-136S). However, surprisingly it is unknown whether treatment of milk with trypsin or other proteases can prevent acid coagulation of milk and thereby confer stability on calcium complexes in acidic medium. It is not obvious, however, to find a convincing reply to this question as long as first, this matter has not been addressed before and second, there are no experimental data available.

It would be therefore desirable to achieve a mechanism that could yield a milk or milk product capable of providing an improved calcium bio-availability without minimal changes or alterations in the organoleptic characteristics of the milk.

### SUMMARY OF THE INVENTION

It is therefore an object of the present invention to provide a milk treated, more particularly a proteolized milk, for increasing the calcium bioavailability in an animal, preferably a vertebrate, most preferably a human being, consuming the milk, wherein the treated milk is more resistant to acid coagulation than any other non treated milk, and wherein the treated milk may be consumed directly and immediately after undergoing the treatment.

It is another object of the invention to provide a new milk that is treated with protease for producing a controlled proteolysis, wherein the protease may comprise any know protease such as subtilisin, bromelain, papain, trypsin, pancreatin, proteases from Aspergillus sp, porteases from Tetrahymena sp, proteases from Bacillus subtilis, B. amyloliquefaciens and B. licheniformis.

It is still another object of the present invention to provide a milk that is controllably proteolyzed and is provided with an increased calcium bioavailability for an animal, preferably a vertebrate animal, consuming the milk, wherein the milk has a resistance to acid coagulation higher than the resistance of a non treated milk and the treated milk is provided with organoleptic characteristics similar to those of untreated milk, for direct consumption or for preparation of dairy products.

It is a further object of the present invention to provide a method for treating a milk, such as whole milk, reconstituted milk, concentrated milk, partially defatted milk or nonfat milk, and obtaining a treated milk with higher resistance to acid coagulation, wherein the treated milk is provided with an increased calcium bioavailability for a vertebrate, such as a human being, consuming the treated milk, the method comprising the steps of:

i. adding an effective amount of a protease to a milk under intensive agitation until obtaining a uniform mixture, wherein the protease may comprise subtilisin, bromelain, papain, trypsin, pancreatin, proteases from Aspergillus sp, proteases from Tetrahymena sp, proteases from Bacillus subtilis, Bacillus licheniformis, and proteases from Bacillus amyloliquefaciens and combinations thereof; and

ii. incubating the mixture for a time, preferably between about 3 seconds and about 12 hours, and under conditions enough for partially hydrolyzing the milk proteins, wherein the protease may be added to the milk in a soluble manner or in an insoluble manner and fixed to a solid support, when applied in soluble manner the protease is added in an amount of between about 0.01 ppm and about 100 ppm by weight.

It is still another object of the present invention to provide a milk controllably proteolyzed, the milk calcium bioavailability of the milk in an animal, preferably a mammal, most preferably a vertebrate animal, is increased at least a 5% relative to the calcium bioavailability of any other non treated milk, and wherein the treated milk is from an animal such as antelopes, bison, cows, camels, sheep, goats, buffalos, and deer.

It is another object of the invention to provide a milk-based product comprising at least 1% of a milk a controllably proteolyzed with increased amount of bioavailable calcium for a vertebrate, wherein the milk has a resistance to acid coagulation higher than the resistance of a non treated milk, wherein the milk-based product may comprise yogurt, ice cream, cheese, cheese-like products, cream, milk jam, butter, breads, candies, chocolate, juices.

It is another object of the invention to provide a method for obtaining a milk-based product, comprising:

i. providing a milk;

ii. adding an effective amount of a protease to the milk under intensive agitation until obtaining a uniform mixture;

iii. incubating the mixture for a time, preferably between about 3 seconds and about 12 hours, and under conditions enough for partially hydrolyzing the milk proteins; and

iv. preparing the product by employing the milk treated in steps ii and iii.

The above and other objects, features and advantages of this invention will be better understood when taken in connection with the accompanying drawings and description.

### BRIEF DESCRIPTION OF THE DRAWINGS

FIG. 1 is a milk protein analysis by polyacrylamide gel electrophoresis in the presence of sodium dodecyl sulfate (SDS). Milk samples were treated with the indicated proteases and then diluted 1:20 in Laemmli sample buffer. Bovine serum albumin (BSA, 10 g) was added to each sample as an internal standard. Samples were boiled and electrophoresed on 12% polyacrylamide gels in the presence of SDS and visualized with Coomassie blue. Lanes in gel A correspond to: 1) Neutrase, 5 ppm; 2) Neutrase, 6 ppm; 3) Neutrase, 7 ppm; 4) control (no protease added); 5) Alcalase 5 ppm; 6) Alcalase 10 ppm; 7) Alcalase 15 ppm; 8) BSA; 9) Molecular weight markers (Rainbow, medium range, Amersham, Buckingamshire, UK).

Lanes in gel A correspond to: 1) Control; 2) discarded lane; 3) Alcalase 5 ppm; 4) Alcalase 10 ppm; 5) Pancreatin 80 ug/ml; 6) Bromelain 40 ug/ml; 7) Aspergillus niger protease 40 ug/ml; 8) Trypsin 10 ug/ml; 9) Molecular weight markers, as in A. Molecular weights of marker proteins are indicated on the right.

FIG. 2 shows the radioactivity recovered measured in tails of mice 30 min after ingestion of control or proteolyzed milk to which the same amount of ⁴⁵Ca was added. The results show the average ±SD of three animals in each group.

FIG. 3 shows the changes in plasma ionized calcium, total serum calcium, serum phosphate, as a function of time, and calcium excretion in 5h, in a human subject after ingestion of 500 ml of control or proteolyzed milk of the invention, and

FIG. 4 shows changes with respect to baseline values in ionized calcium levels in plasma at 3 hours after ingestion of control or proteolyzed milk (I-Ca 3h—I-Ca 0h, mM). The mean baseline value was 1.21 mM. The highest I-Ca recorded with proteolyzed milk was 1.32 mM.

### DETAILED DESCRIPTION OF THE PREFERRED EMBODIMENTS

For the purpose of the present description the term “food” and “food product” is understand as defined in Code of Federal Regulations, Title 21.

According to the invention a limited or controlled proteolysis is employed with he aim of obtaining a proteolyzed milk that does not coagulate by itself and shows a marked resistance to coagulation in the presence of acid, increasing the calcium bioavailability in animals and/or human subjects consuming the inventive controllably proteolyzed milk. Also, according to the invention, proteases are employed which facilitate the limited proteolysis and which generate a hydrolyzed protein pattern in SDS-PAGE that depends on the employed protease, wherein the milk treated according to the invention keeps its visible organoleptic characteristics unaltered.

Particularly unexpected is the striking change in the milk behavior upon acidification after treatment of the milk with Neutrase or Alcalase, which enzymes have minor or undetectable effect on the protein patterns as revealed by SDS-PAGE. Yet, the treated milk does not coagulate on addition of acid.

It is important to remark that while a person skilled in the art would associate the enhanced calcium bioavailability to the appearance of free casein phosphopeptides in the milk treated with proteases, it has been surprising to find that free casein phosphopeptides are not formed in detectable amounts in milk treated according to the invention with most of proteases and yet the treated milk showed enhanced calcium bioavailability. An explanation to this surprising effect is that the subtle proteolysis effected alters the charge dependency of casein micelles on pH rendering the micelles resistant to coagulation in acidic conditions, conferring stability to calcium complexes.

The present invention addresses the mechanisms for stabilizing calcium complexes in acidic medium to increase the bioavailability of calcium naturally occurring in the milk. It is especially suited for bone health because, in addition to providing calcium, it contains phosphate, magnesium and an almost complete set of nutrients, whose consumption provide a “meal effect”. This fosters the absorption of calcium provides a simultaneous intake of phosphorous that is essential for bone deposition. These advantages cannot be provided by any other source of calcium, such as calcium supplements or calcium-rich waters. It is therefore of particular interest to improve milk nourishing properties.

Milk rendered resistant to acid coagulation by the method disclosed here is obtained by a simple and inexpensive method, easily amenable to industrial scale-up. This milk provides the whole set of nutrients present in milk needed to promote bone deposition. It is superior to calcium supplements, because it provides the entire mineral set needed for bone formation, and not only calcium.

The milk resistant to acid coagulation of the invention can be expected to offer better digestibility since digestive enzymes have better access to their substrates if they are in the form of a fine dispersion than if they are in coagulated large clumps.

The method described herein includes the use of proteases with a long history of safe use in food treatment, enjoying FDA-affirmed GRAS (generally regarded as safe) status. This makes milk treated as described here easily marketable.

In addition, milk treated as described herein has similar appearance to regular milk and even can maintain the same natural taste and odor. Therefore, the inventive milk can be marketed as regular fluid milk, although it is also possible to add flavors and sweeteners, if desired.

Other advantage of this invention is that proteases may destroy allergenic antigens in milk proteins, which are responsible for milk intolerance in a substantial number of children and adults. Still another advantage of treating milk with proteases is that it may be a suitable way for sanitizing milk against prions, such as those causing bovine spongiform encephalitis (BSE) or mad cow disease, since these infectious agents are of protein nature.

It is important to emphasize that the current market trends demand solutions to insufficient calcium uptake, which may lead to osteoporosis and other ailments. Enhanced bioavailability of calcium appears as an effective way to fight this type of disease. Because more calcium is available to the body when milk resistant to acid coagulation of the invention is consumed, such milk is especially recommendable for those who need to restrict calorie intake without compromising bone health. In other words, less milk calories need to be ingested to take up desirable levels of calcium. Thus, milk resistant to acid coagulation of the invention may become a dietary element, useful to fight obesity and preserve at the same time cardiovascular and bone health.

A thermal treatment may be used to inactivate the added enzyme. In this case, a sterile or close to sterile milk product is obtained. This makes it safer and may confer long product durability, reducing or eliminating losses due to spoilage.

It is also possible to produce milk resistant to acid coagulation using a protease immobilized on a solid phase. In this case, the enzyme can be removed by filtration and other means to interrupt proteolysis, eliminating the need of thermal treatment. This does not preclude the use of such treatment to pasteurize or sterilize the treated milk.

Milk resistant to acid coagulation described here is at least as stable as regular milk and it is therefore amenable to processing by ultra high temperature (UHT) treatment. Such treatment eliminates the need for refrigeration and the product keeps for several months.

Milk resistant to acid coagulation obtained by limited and controlled enzymatic proteolysis disclosed herein results from the unexpected experimental observation that milk can be treated with proteases under controlled conditions, so that it does not show any clotting or precipitation, maintaining natural appearance but reacting in markedly different way from untreated milk to the addition of acid. As noted the electrophoretic protein patterns show little or undetectable changes in the milk after treatment with Alcalase or Neutrase. It is surprising that such subtle action of the enzymes can alter so strikingly the response of the milk to acidification and this takes place without the taste being altered. While, upon addition of acid, untreated milk forms large and stiff coagula, the protease-treated milk remains fluid. The inventors hypothesized that resistance to acid coagulation would be reflected in an increased calcium bioavailability, because coagulation involves the coalescence of casein and calcium phosphate micelles into large clumps that form the coagulum. Entrapment in the coagulum imposes a physical limitation to calcium diffusion, limiting thereby its bioavailability. This same effect of coagulation may affect other components of nutritional value in milk, but calcium is a main concern because of the health problems associated with insufficient calcium absorption. The protease is added to milk under conditions that allow good mixing. Incubation is then carried out for a limited period of time under controlled temperatures. If soluble protease is used, proteolysis is terminated by heat-denaturing of the enzyme. If insoluble protease is used, as in the case of enzymes covalently attached to solid matrices, proteolysis is stopped by physical separation of enzyme from treated milk. These physical means include filtration, sedimentation, centrifugation, magnetic separation and other common procedures. If the immobilized enzyme is attached to an extended surface support, such as a cartridge, the reaction can take place as milk contacts such extended surface and terminates as this contact is interrupted.

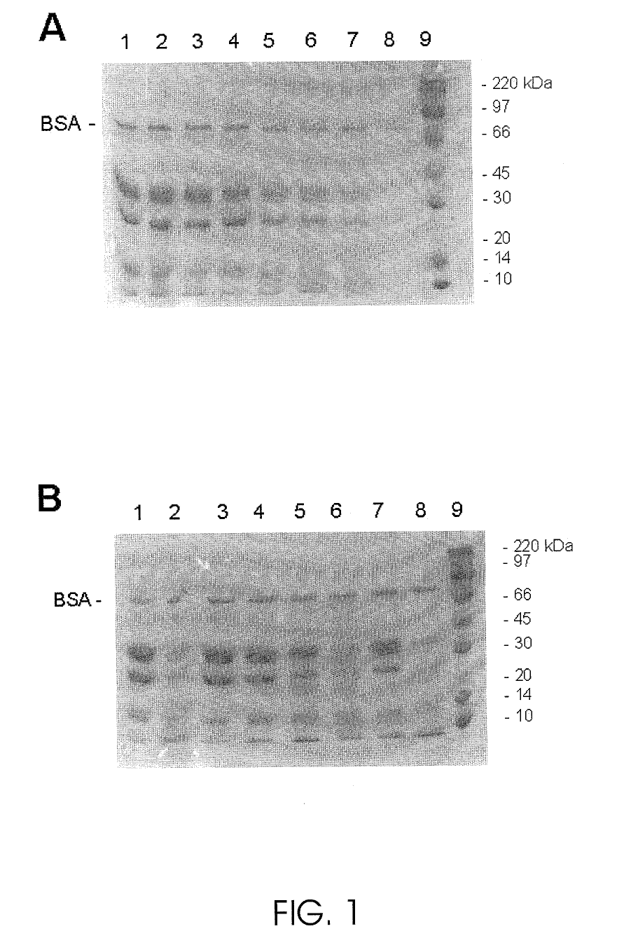

The degree of hydrolysis that produces milk resistant to acid coagulation of the invention is different for each protease. In the preferred embodiment, 5 ppm of Alcalase 2.4L FG (Novozymes, Franklinton, N.C.) was added to milk at room temperature (22° C.) and the mixture was heated at a rate of about 2.7° C./min until it reaches 85° C. The mixture was then kept for 10 min at this latter temperature to inactivate the protease. In these conditions, milk is rendered resistant to acid coagulation, without any change in visible organoleptic properties nor in taste or odor being noticed. A higher concentration (10 ppm) produces partial clotting with the appearance of finely dispersed aggregates. At 15 ppm, frank milk clotting is observed. Slight proteolysis of milk proteins is observed at 5 ppm (FIG. 1A, lane 5), while at concentrations of 10 and 15 ppm, proteolytic effects are evident (FIG. 1A, lanes 6 and 7). If a steeper heating rate is used (about 3.8° C./min), milk resistant to acid coagulation can be obtained with 10 ppm of alcalase, and no clotting or change in sensory properties are observed in this case. This indicates that enzyme concentration and heating rates can be adjusted to shorten treatment times.

In another embodiment, a number of proteases were investigated for their possible use to obtain milk resistant to acid coagulation. The temperature conditions in this case were a heating rate of about 3.8° C./min from room temperature to 85° C. and then, maintaining this temperature for 10 min. In the case Neutrase (Novozymes, Franklinton, N.C.), the useful range of enzyme concentrations is narrower. At 6 ppm, resistance to acid coagulation is obtained, while a concentration of 5 ppm is insufficient to cause this effect and 7 ppm causes milk clotting. Surprisingly, no proteolytic effects are detectable in these samples (FIG. 1A, lanes 1-3).

A low level of proteolysis is also characteristic of the milk resistant to acid coagulation obtained using 40 microgram/ml Aspergillus niger protease (Sigma Chemical Co., St. Louis, Mo., catalog No. P4032) (FIG. 1B, lane 7). A higher concentration of this enzyme results in milk clotting. Marked hydrolysis is also observed (FIG. 1B, lane 6) in milk resistant to acid coagulation obtained with 40 microgram/ml bromelain (Sigma chemical Co., catalog No. P4882). At 80 microgram/ml, this enzyme causes milk clotting. Milk resistant to acid coagulation can be obtained with 80 microgram/ml pancreatin (Sigma Chemical Co., catalog No. 7545), FIG. 1B, lane 5, without appearance of bitter taste, while 10 microgram/ml trypsin (Sigma Chemical Co., catalog No. T0134) yields complete resistance to acid coagulation. Strikingly, this enzyme does not clot milk even upon after extensive protein degradation (FIG. 1B, lane 8). This unexpected result suggests that calcium phosphate-stabilizing casein phosphopeptides are sufficient to keep whole milk colloidal structure. Because this type of milk possesses slight bitter taste, it could require the addition of adequate amounts of sweeteners/flavoring agents.

In the embodiments of the invention above disclosed, the milk coagulation or clotting has been evaluated by employing the following test: 9 volumes of a milk sample has been mixed with 1 volume of acetic acid, the mixture was allowed to stand for 5 min at room temperature and then, the vial was capped and manually shaken by repeated inversion. While regular milk forms stiff aggregates upon this treatment, with visible coagulation, the inventive milk, highly resistant to acid coagulation, remained fluid, without clotting.

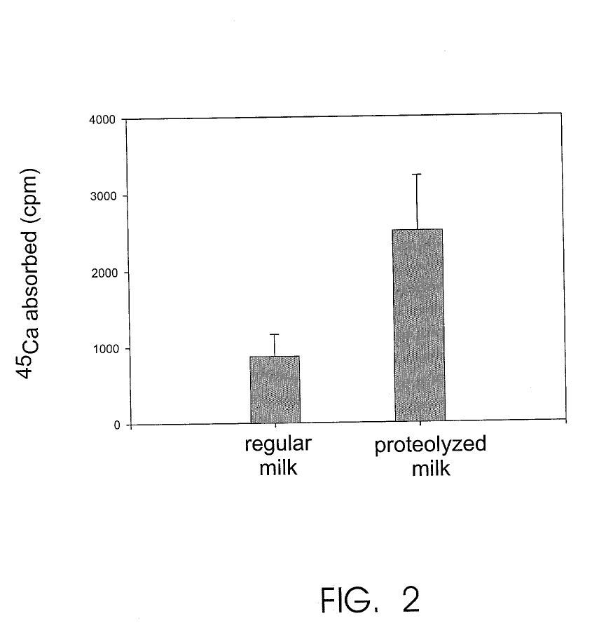

Radiotracer experiments in mice showed that milk of the invention rendered resistant to acid coagulation yielded a 2.8 to 3 fold increase in absorption of ⁴⁵Ca, with respect to the control, non proteolyzed milk (FIG. 2).

This test in mice allows to compare the relative amounts of calcium absorbed by the mouse intestine. More particularly, the calcium found in the mice tale is a good indication that that the calcium has been absorbed and passed through the intestine epithelium into the blood circulatory system.

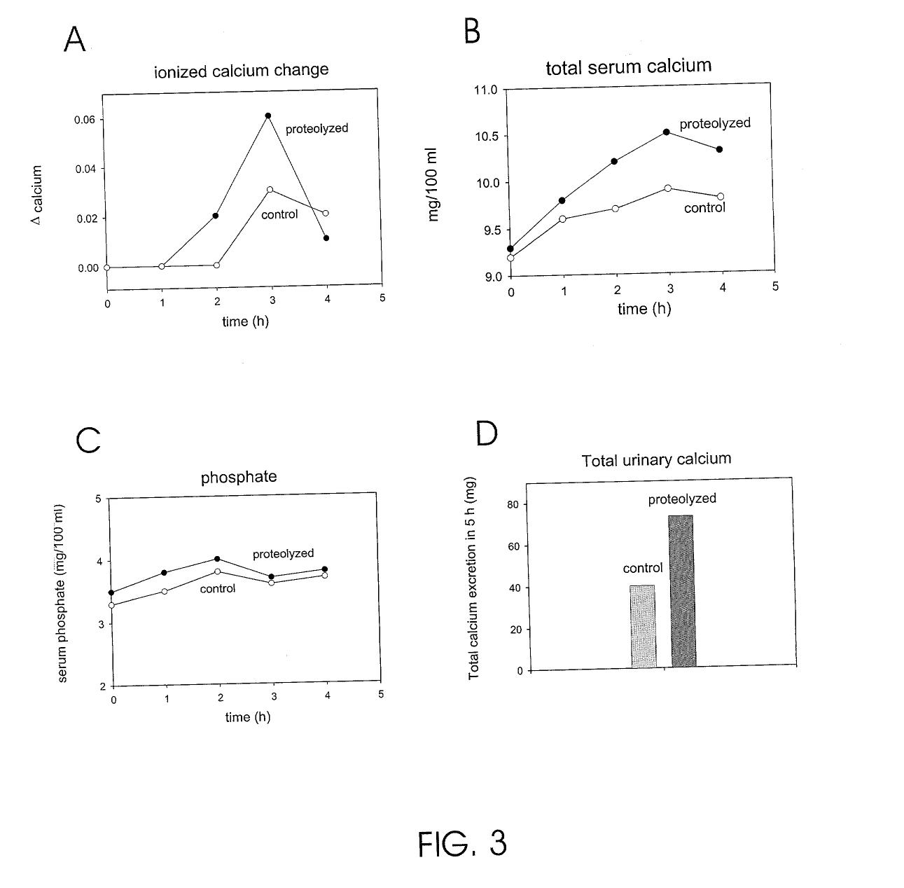

The milk of the invention can also enhance calcium bioavailability in human subjects. For example, measurements of Ionized Calcium (I-Ca) showed increase in its level after ingestion of both with control and limited proteolyzed milk of the invention, which peak at 3 hours. The increases were consistenly higher when proteolyzed milk of the invention was ingested (FIGS. 3A and 3B). Total calcium followed a similar pattern and no major changes were found in the levels of either serum phosphate (FIG. 3C) or magnesium (not shown). Urinary calcium excretion during the experimental period was considerably higher when proteolyzed milk was used (FIG. 3D).

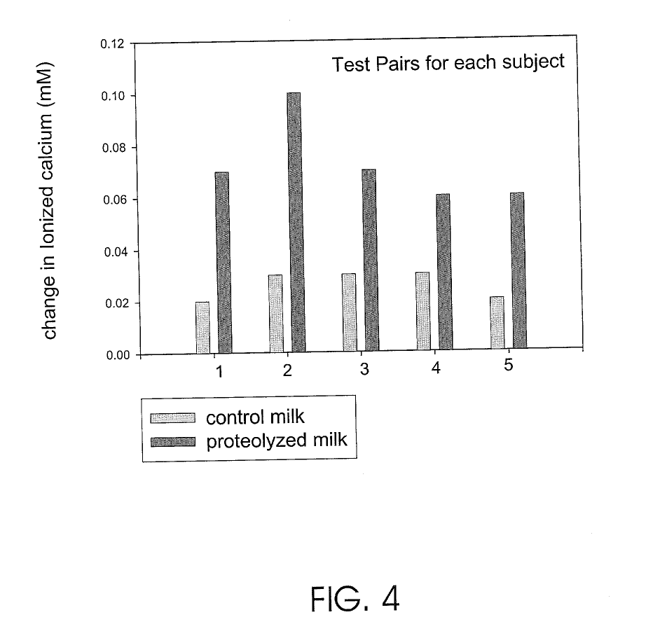

FIG. 4 compares the ionized calcium changes induced by either control or proteolyzed milk in 5 different subjects at 3 h after ingestion. It is noticeable that proteolyzed milk of the invention induces significantly larger changes than control milk. Ingestion of proteolyzed milk induced a 2 to 3.3-fold larger change in I-Ca levels than control milk, with an average of 2.8-fold.

It is evident that ingestion of proteolyzed milk is associated with higher urine calcium. In separate experiments, we found that already at 3 h, calcium excreted in urine is increased in proteolyzed milk by an average 2.5-fold (range 1.75 to 3.5) over the amount excreted after drinking control milk. When urine collection was extended to cover a full 24 h period the difference was 1.6-fold (range 1.24 to 1.94) (Table 1). These results indicate that urinary calcium excretion appears to be a suitable test to compare calcium bioavailabilities, as it is well known in the art.

TABLE 1
Calcium contents (grams) in total urines collected during
5 hs. after ingestion of control or proteolyzed milk

| Experiment* | Control milk | Proteolyzed milk |
|---|---|---|
| 1 | 0.189 | 0.340 |
| 2 | 0.110 | 0.264 |
| 3 | 0.189 | 0.350 |
| 4 | 0.144 | 0.279 |
| 5 | 0.156 | 0.245 |
| Average | 0.157 ± 0.033 | 0.296 ± 0.047 |

*To facilitate reference to standard daily excretion values (0.175 g per day), results were calculated as the corresponding 24 h-calcium excreted values, assuming constant excretion rates.

The data gathered in this study strongly suggest that proteolysis enhances calcium absorption from milk in human subjects, as it does in mice. I-Ca changes suggest that this enhancenent may be 2 to 3-fold, and urinary excretion values support a similar conclusion.

The use of proteases under controlled conditions to modify milk proteins and prevent the coagulation on acid has not been described in the previous art. The treatment with proteases we describe here not only does not coagulate milk, but actually prevents its acid coagulation enhancing milk calcium bioavailability, a hitherto unknown result.

Therefore, the treated milk invented here, is mainly meant for direct consumption without fermentation, since it has essentially unaltered sensory properties, and provides enhanced bioavailability of naturally occurring milk calcium.

It is worth emphasizing that the present Patent Application does not refer to calcium-fortified milk. Rather, a characteristic and novel feature of this invention is that it results in an enhanced calcium bioavailability of milk. This can be explained by its resistance to coagulation in the stomach acidic medium, thus offering calcium in a more suitable way for uptake, i.e. finely dispersed versus retained in the coagulum, as it normally occurs with regular milk.

The inventive milk may be employed as regular in fluid status for direct consumption or may be used for elaborating milk-based products.

As any person skilled in the art may understand, the inventive milk may derive from any proper animal such as cows, sheep, goat, bison, antelope, deer and camel. It is also clear that the partially hydrolyzed milk treated according to the invention may be consumed by any vertebrate either in need or not of the milk for increasing the calcium bioavailability. Consuming the milk of the invention is particularly useful and advantageous for treating disorders and diseases such as osteoporosis, osteogenesis imperfecta, rickets, osteomalacia.

The invention is further illustrated in the following examples which are not intended to be in any way limiting to the scope of the invention as claimed.

### EXAMPLE 1

Treatment of Milk Employing the Alkaline Proteasa of Bacillus Licheniformis

5 ppm of alkaline proteasa of Bacillus licheniformis, food grade (Alcalase 2.4L FG, obtained from Novozymes North America Inc. (Franklinton, N.C., USA)) has been added to the milk under stirring, and the mixture was heated to 63° C., and kept at said temperature for 30 minutes.

Then the mixture was heated to 85° C. and kept at this temperature for 10 minutes for denaturalizing the protease according to indications of the enzyme provider. The proteolized milk was quickly cooled down by passing the container with the proteolized milk into a water bath. The heating velocity was 2° C. to 3° C. per minute.

Considering the several industrial pasteurization processes known in the art, the method of the invention was tested for elaborating pasteurized milk of the type Tetrapack. The process consists of milk prepared by mixing, under constant stirring, whole cow milk with 7 parts per million by volume of Alcalase 2.4L FG, obtained from Novozymes North America Inc. (Franklinton, N.C., USA), at room temperature. To facilitate the handling of the small amounts of enzyme required, a previous dilution 1:100 (v/v) in distilled water is prepared. The mixture is then heated at a rate of about 2.6° C./min, until it reaches the temperature of 85° C., at which it is held for 10 min to denature the protease and terminate the reaction. Treated milk is then cooled down to room temperature and stored at 4° C. until use In both above mentioned processes the stability of the partially proteolized milt in the presence of an acid medium was evaluated by mixing, in Eppendorf type vial, nine (9) parts (450 μl) of proteolized or control milk with one (1) part (50 μl) of glacial acetic acid. This mixture was allowed to settle for five (5) minutes and then the coagulation status or resulting homogeneity and fluidity were examined. This was carried out by inverting and slightly agitating the vial. Non treated milk was employed as control.

### EXAMPLE 2

Treatment of Milk Employing Neutrase

6 ppm of Neutrase (Novozymes, Franklinton) were added to milk under stirring and the mixture was under a heating rate of about 3.8° C./min from room temperature to 85° C. and then, was kept at this temperature for 10 min.

The coagulation tests were carried out as it is described in Example 1.

### EXAMPLE 3

Treatment of Milk Employing Aspergillus Niger Protease

It was carried out in a manner similar to the one of Example 2, but the Neutrase was replaced by 40 μg/ml of Aspergillus Níger protease (Sigma Chemical Co., St. Louis, Mo., catalog # P4032).

The coagulation tests were carried out as it is described in Example 1.

### EXAMPLE 4

Treatment of Milk Employing Bromelain

It was carried out in a manner similar to the one of Example 2, but the Neutrase was replaced by 40 μg/ml of bromelain (Sigma Chemical Co., St. Louis, Mo., catalog # P4882).

The coagulation tests were carried out as it is described in Example 1.

### EXAMPLE 5

Treatment of Milk Employing Pancreatin

It was carried out in a manner similar to the one of Example 2 but the Neutrase was replaced by 80pg/ml of pancreatin (Sigma Chemical Co., St. Louis, Mo., catalog # 7545).

The coagulation tests were carried out as it is described in Example 1.

### EXAMPLE 6

Treatment of Milk Employing Trypsin

It was carried out in a manner similar to the one of Example 2, but the Neutrase was replaced by 10 μg/ml of trypsin (Sigma Chemical Co., St. Louis, Mo., Catalog T0134). Trypsin, as employed according to the invention, does not cause clotting even after a very extensive proteolysis and the resulting hydrolyzates show a marked stability to the addition of acids without any coagulation being detected.

The coagulation tests were carried out as it is described in Example 1. In this case a strong bitter taste is produced, therefore requiring the addition of sweeteners or flavoring agents before consumption.

### EXAMPLE 7

⁴⁵Ca Absorption Test in Mice

The assay was conducted in mice that were fasted for 24 h, during which they only had unlimited access to water. Identical amounts of ⁴⁵Ca, as ⁴⁵CaCl₂ (1 Ci/ml) were added to aliquots of milk resistant to acid coagulation and control milk (no protease, only vehicle added) and the mixture was allowed to equilibrate for 24 h at 4° C. prior to use. Mice were placed in individual containers and 50 1 of the radiotracer-labeled milk were placed in each container. Thirty minutes after the mice spontaneously drank the whole milk aliquot, they were killed by exposure to diethylether vapor, washed and 5 cm of their tails cut, weighed and the radioactivity present was counted by liquid scintillation.

### EXAMPLE 8

Calcium Absorption Test in Healthy Volunteer Human Beings

The assay was conducted with milk treated only with food grade enzymes. The ingestion of this treated milk was authorized in a protocol of sensitive analysis of milk, approved by a experiments reviewing committee consisting of individuals from Washington State University.

After a 12 h fasting period, five human subjects, aged 21 to 50 (four females, one male) were asked to drink 500 ml of milk resistant to acid coagulation of the invention, or control milk, in two different sessions separated by 48 h.

Briefly, milk resistant to acid coagulation of the invention was prepare under a standardized protocol that included a 10 min. heating period at 85° C., to inactivated the added protease. In all cases, whole UHT milk without added vitamin D and a commercial food grade protease was used.

Total urine was collected before the milk ingestion (hour 0) and at 3, 5 and 24 hours post ingestion the calcium volume and concentration was measured for obtaining the total calcium excreted in that period. The blood samples were obtained at hour 0 and for the following 4 hours at intervals of 1 hour.

The urinary calcium samples were evaluated by the Arsenazo III calorimetric method.

The ionized calcium levels were evaluated according to the following protocol. Aliquots of the blood simples were placed in glass heparinized tubes, rapidly centrifuged and the plasma immediately used for measuring Ionized Calcium (I-Ca) using a calcium selective electrode. Another aliquot of each blood sample was transferred to a polystyrene tube and incubated at 37° C. for 30 min, to separate the serum, which was used for measurement of total calcium, phosphate and magnesium.

I claim:

1. A milk that is controllably proteolyzed and is provided with an increased calcium bioavailability for an animal consuming the milk, wherein the milk has a resistance to acid coagulation higher than the resistance of a non treated milk and the treated milk maintains unaltered visible organoleptic characteristics for direct consumption.

2. The milk of claim 1, wherein the milk is incubated with an effective amount of a protease for a limited time and under conditions where the milk proteins are partially hydrolyzed without clotting.

3. The milk of claim 2, wherein the protease is selected from the group consisting of subtilisin, bromelain, papain, trypsin, pancreatin, proteases from Aspergillus sp, proteases from Tetrahymena sp, proteases from Bacillus subtilis, Bacillus licheniformis, and proteases from Bacillus amyloliquefaciens or combinations thereof.

4. The milk of claim 1, wherein the calcium bioavailability of the milk in a mammal is increased at least a 5% relative to the calcium bioavailability of any other non treated milk.

5. The milk of claim 1, further comprising additives selected from the group consisting of thickeners, vitamins, sweeteners, dyes, flavors and minerals.

6. The milk of claim 1, wherein the milk is selected from the group consisting of whole milk, reconstituted milk, concentrated milk, partially defatted milk and nonfat milk.

7. The milk of claim 1, wherein the milk is from an animal selected from the group consisting of antelope, bison, cows, camels, sheep, goat, buffalo, and deer.

8. A method for treating a milk and obtaining a treated milk with higher resistance to acid coagulation, wherein the treated milk is provided with an increased calcium bioavailability for a vertebrate consuming the treated milk, the method comprising the steps of:
i. adding an effective amount of a protease to a milk under intensive agitation until obtaining a uniform mixture; and
ii. incubating the mixture for a time and under conditions enough for partially hydrolyzing the milk proteins.

9. The method of claim 8, wherein the step of incubating the mixture comprises incubating the mixture for a time between about 3 seconds and about 12 hours.

10. The method of claim 8, wherein the milk is selected from the group consisting of whole milk, reconstituted milk, concentrated milk, partially defatted milk and nonfat milk.

11. The method of claim 8, wherein the milk is from an animal selected from the group consisting of antelope, bison, cows, camels, sheep, goat, buffalo, and deer.

12. The method of claim 8, wherein the vertebrate animal is a human being.

13. The method of claim 8, wherein the protease is selected from the group consisting of subtilisin, bromelain, papain, trypsin, pancreatin, proteases from Aspergillus sp, proteases from Tetrahymena sp, proteases from Bacillus subtilis, Bacillus licheniformis, and proteases from Bacillus amyloliquefaciens and combinations thereof.

14. The method of claim 8, wherein the protease is added to the milk in a soluble manner.

15. The method of claim 8, wherein the protease is added to the milk in an insoluble manner and fixed to a solid support.

16. The method of claim 8, wherein the calcium bioavailability of the milk in a mammal is increased at least a 5% relative to the calcium bioavailability of any other non treated milk.

17. The method of claim 8, wherein the protease is added to the milk in an amount of between about 0.01 ppm and about 100 ppm by weight.

18. The method of claim 8, further comprising the addition of additives selected from the group consisting of thickeners, vitamins, sweeteners, dyes, flavors and minerals.

19. A milk-based product comprising a milk resistant to acid coagulation which has been prepared according to claim 8, wherein said product is selected from the group consisting of yogurt, ice cream, cheese, cheese-like products, cream, milk jam, butter, breads, candies, chocolate and juices.

20. A method for obtaining a milk-based product, comprising:
i. providing a milk;
ii. adding an effective amount of a protease to the milk under intensive agitation until obtaining a uniform mixture;
iii. incubating the mixture for a time and under conditions enough for partially hydrolyzing the milk proteins; and
iv. preparing the product by employing the milk treated in steps ii and iii.

21. The method of claim 20, wherein the step of incubating the mixture comprises incubating the mixture for a time between about 3 seconds and about 12 hours.
